(19) United States
(12) Patent Application Publication
(10) Pub. No.: US 2007/0230538 A1
(43) Pub. Date: Oct. 4, 2007

(54) Thermometer

(75) Inventors: Jeff Koon, Lombard, IL (US); Mike Manion, McHenry, IL (US); Lisa Dodge, Oak Park, IL (US); Liz Wentland, Chicago, IL (US)

Correspondence Address: BROOKS KUSHMAN P.C., 1000 TOWN CENTER, TWENTY-SECOND FLOOR, SOUTHFIELD, MI, 48075, US

(73) Assignee: Taylor Precision Products, Inc., Oak Brook, IL (US)

(21) Appl. No.: 11/395,660

(22) Filed: Mar. 31, 2006

(51) Int. Cl. G01K 5/00; G01K 1/00

(52) U.S. Cl. 374/205; 374/208

(57) ABSTRACT

A thermometer. In at least one embodiment, the thermometer includes a dial plate having a dial surface including indicia, a temperature probe and an indicator overlying and moveable relative to the dial plate and the indicia thereon to indicate a temperature reading corresponding to the temperature of the probe. At least a portion of the indicator having a luminescent composition to provide a glowing light to enhance the visibility of the temperature reading under low light conditions.

### BACKGROUND OF THE INVENTION

1. Field of the Invention

One aspect of the present invention relates to a thermometer, and in certain embodiments, a thermometer for measuring the internal temperature of a cooking meat.

2. Background Art

Meat thermometers are used to measure the internal temperature and the cooking stage of a cooking meat. Meat thermometers can be useful for preventing overcooking, undercooking and indicating that the cooking meat has reached a temperature sufficient to eradicate pathogens that may otherwise cause food borne illness. Many meat thermometers have markings for recommended temperatures for cooking certain meats, for example, chicken, pork, and beef. Some recently introduced meat thermometers include light-emitting diodes or buzzers to alert the user when a desired temperature is met during cooking.

A typical meat thermometer is comprised of a rod, usually formed of metal, which is placed into the meat to be measured, and a display, usually a dial or LCD display. Dail meat thermometers typically include a dial face having temperature indicia arranged in a circular configuration and an indicator capable of rotational movement in response to a temperature change in the cooking meat. During use, the indicator becomes aligned with a temperature indicium that corresponds to the temperature that the rod is exposed to, i.e. the internal temperature of the cooking meat.

In order for the user to make use of the temperature reading, the user must be able to view the temperature indicia and the indicator position. It may be difficult to view the temperature indicia and indicator while cooking under low light or dark conditions, for example, outside barbequing at night. One proposal attempts to address this difficulty by applying a luminescent material coating onto a portion of the dial face. When exposed to low light or dark conditions, the luminescent ink glows and thereby accentuates the visibility of the temperature indicia. Although this approach may enhance the visibility of the temperature indicia, the visibility of the indicator is not addressed, thereby leaving the possibility that the user experiences difficulty in reading the indicated temperature of the cooking meat.

According to another proposal, a battery-powered light bulb can be secured to the interior or exterior of the meat thermometer to illuminate the dial face, including the indicia and indicator. While this approach may be successful in alleviating visibility problems in poor light conditions, it may add to material costs (e.g. light bulb, batteries, mounting assembly, battery housing, etc.) and bulkiness and size (e.g. battery housing). Therefore, this proposal does not satisfactorily address the visibility issue when utilizing a meat thermometer in poor light conditions.

There has been a recent rise in the consuming public's utilization of outdoor cooking, such as barbequing. With the recent upswing in such cooking techniques, being able to effectively use a meat thermometer in a poor light conditions has become a more pressing need for consumers. Therefore, there is a need to development a meat thermometer that addresses visibility concerns.

### SUMMARY OF THE INVENTION

According to one embodiment of the present invention, a thermometer is disclosed. The thermometer includes a dial plate having a dial surface including indicia, a temperature probe and an indicator overlying and moveable relative to the dial plate and the indicia thereon to indicate a temperature reading corresponding to the temperature of the probe. At least a portion of the indicator has a luminescent composition to provide a glowing light to enhance the visibility of the temperature reading under low light to dark conditions.

According to another embodiment of the present invention, a thermometer is disclosed. The thermometer includes a dial plate having a dial surface including indicia, a temperature probe and an indicator overlying and moveable relative to the dial plate and the indicia thereon to indicate a temperature reading corresponding to the temperature of the probe. At least a portion of the indicator has a first luminescent composition and at least a portion of the dial plate has a second luminescent composition to provide glowing light to enhance the visibility of the temperature reading under low light conditions.

In yet another embodiment of the present invention, a thermometer is disclosed. The thermometer includes an elongated probe assembly and a dial case assembly. The elongated probe assembly includes an elongated temperature probe and a shaft situated within the elongated temperature probe and capable of rotational movement in response to a change in temperature of the probe. The dial case assembly includes a dial plate having a dial surface including indicia arranged in a circular configuration and an indicator overlying and rotatably moveable relative to the dial plate and the indicia thereon to indicate a temperature reading corresponding to the temperature of the probe. The indicator is rotatably moveable in response the rotational movement of the shaft. The elongated probe assembly and dial case assembly are rigidly connected. At least a portion of the indicator has a luminescent composition to provide a glowing light to enhance the visibility of the temperature reading under low light conditions.

These and other aspects of the present invention will be better understood in view of the attached drawings and following detailed description of the invention.

### BRIEF DESCRIPTION OF THE DRAWINGS

The features of the present invention which are believed to be novel are set forth with particularity in the appended claims. The present invention, both as to its organization and manner of operation, together with further object and advantages thereof, may best be understood with reference to the following description, taken in connection with the accompanying drawings which:

FIG. 1 is a plan view of a thermometer in accordance with one embodiment of the present invention;

FIGS. 2a and 2b are cross sectional views of the thermometer depicted in FIG. 1 taken along line 2a-2a of FIG. 3;

FIG. 3 is a top view of the thermometer depicted in FIG. 1; and

FIG. 4 is an end view of the thermometer depicted in FIG. 1.

### DETAILED DESCRIPTION OF EMBODIMENTS OF THE PRESENT INVENTION

As required, detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

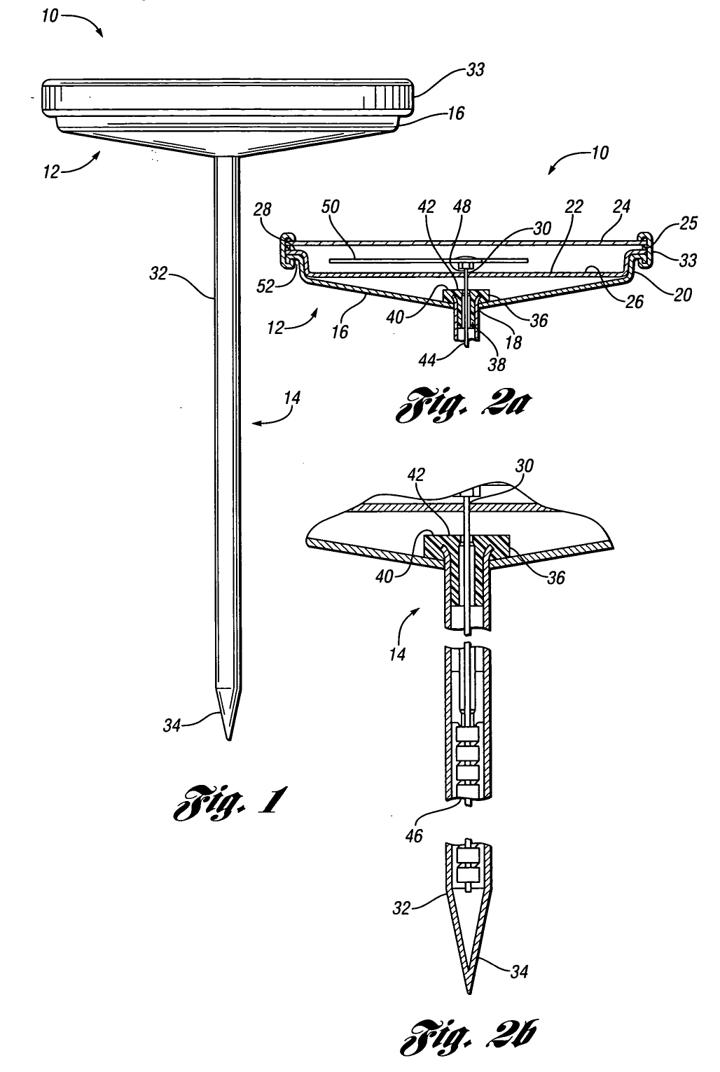

Referring now to FIG. 1, a thermometer 10 according to at least one embodiment of the present invention is shown. Thermometer 10 can be used as a meat thermometer for measuring the temperature of cooking meat, e.g. chicken, pork or beef and/or the doneness of cooking meats, e.g. rare, medium, well for beef. In at least one embodiment, the thermometer is a deep fry thermometer for measuring the temperature of a cooking oil. The deep fry thermometer can have a clip for securing the thermometer to a deep frying pot or pan. In at least one embodiment, the probe length of the deep fry thermometer is longer than the meat thermometer probe length.

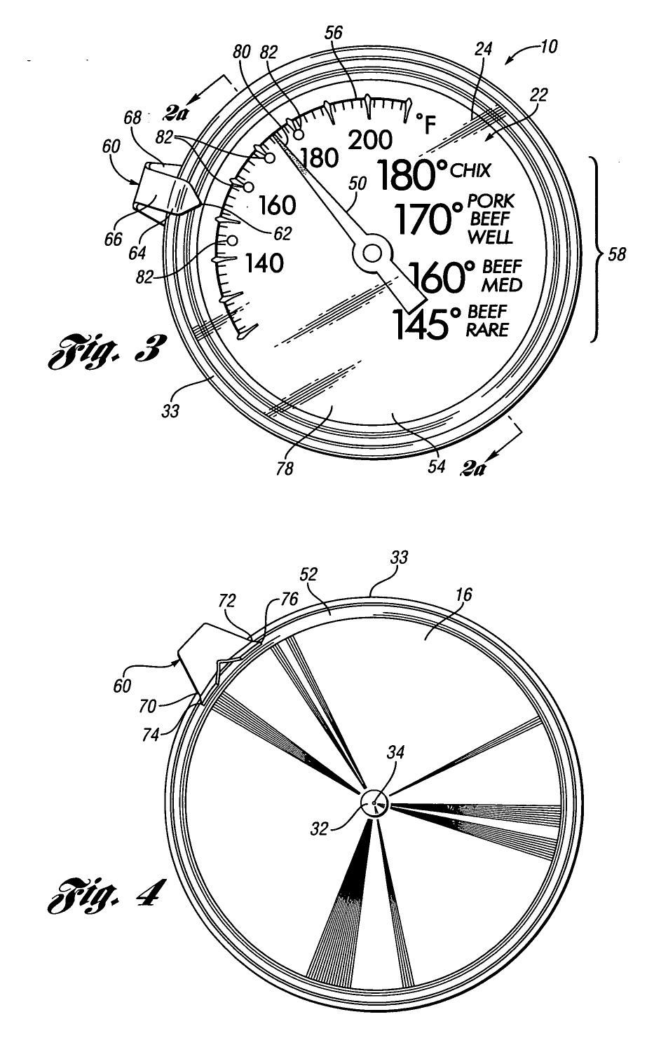

Thermometer 10 generally includes dial case assembly 12 and probe assembly 14, which are joined to one another to provide a unitary construction. Referring now to FIGS. 1 and 2, dial case assembly 12 includes a unitary annular outer case wall 16 having a central opening 18 and an outermost flange section 20.

Dial case assembly 12 further includes an annular dial plate 22, annular transparent cover 24, and an annular dial case spacer 25. As depicted in FIGS. 2a and 2b, the annular transparent cover 24 is substantially flat. It should be appreciated that according to other embodiments of the present invention, the annular transparent cover can be domed. The annular dial case spacer 25 can be constructed of a plastic or rubber material. The annular dial plate 22 includes an inner annular flat section 26, an outermost flange section 28, and central opening 30.

Dial case assembly 12 further includes an annular circumferential case wall 33 for joining the outermost flange section 20 of the unitary annular outer case wall 16, the outermost flange section 28 of annular dial plate 22, the annular dial case spacer 25, and the annular transparent cover 24. The joining of these structures can be accomplished with a press-fitting process or other suitable process known to one of ordinary skill in the art to provide a rigid assembly to dial case assembly 12. Annular dial recess 52 is formed between annular circumferential case wall 33 and unitary annular outer case wall 16 during the joining process.

Annular dial recess 52 serves as a circumferential guide for positioning a desired temperature pointer indicator 60, as shown in FIGS. 3 and 4. Pointer indicator 60 includes a pointed end 62 for alignment with an indicium of temperature indicia 56, a curved upper section 64 for engaging the upper curved surface of the annular circumferential case wall 33, an angled flat upper section 66, a tapered lower section 68, first and second tapered legs 70 and 72, and first and second curved feet 74 and 76 engaging the opposing side walls of the annular dial recess 52. This construction provides a relatively tight friction engagement between dial case assembly 12 and pointer indicator 60, but allows for relative rotational movement therebetween.

Moving back to FIGS. 2a and 2b, probe assembly 14 includes an extended probe 32 having a closed and pointed lower end 34 and a bushing 36 which performs the functions of interconnecting dial case assembly 12 and probe assembly 14. Bushing 36 includes a lower cylindrical sleeve 38, an upper annular transverse flange 40 and an upper intermediate journal section 42. Lower cylindrical sleeve 38 can be secured in a press fit in a bore of extended probe 32. The sleeve 38 is positioned so that the upper flat surface of flange 40 underlies dial plate 22.

Probe assembly 14 further includes a central shaft 44 rotatably mounted in the lower end 34 of probe 32. A lower portion of central shaft 44 is surrounded by a thermal, bimetal, expansion spring 46 which serves to change a rotational position of the upper end of shaft 44 in response to a change in temperature of the probe 32. The upper end 48 of shaft 44 extends through journal section 42 of bushing 36 and the central opening 30 in dial plate 22, and rotatably moveable therein.

Upper end 48 has a transversely extending pointer indicator 50 affixed thereto. Pointer indicator 50 overlies dial plate 22 and the indicia 56 thereon, shown in FIG. 3, to provide an indication of the temperature to which probe 32 is exposed to.

Turning now to FIG. 3, a top view of thermometer 10 is shown. Dial plate 22 includes dial face 54, which includes indicia 56 arranged in a circular configuration, which can be viewed through cover 24. The indicia 56 are printed on the dial face 54 with an ink or other suitable marking material. In at least one embodiment, a black ink is utilized. As depicted in FIG. 3, the temperature units are Fahrenheit, the temperature range is 130 to 210 degrees Fahrenheit, and the temperature scale is 1 degree per indicium. It should be appreciated that the temperature range can be different for a deep fry thermometer. In one embodiment, the deep fry thermometer temperature range is 200 to 550 degrees Fahrenheit. Important indicia can be marked with corresponding temperatures. As depicted in FIG. 3, the temperatures of 140, 160, 180 and 200 degrees Fahrenheit are marked. It should be understood that other temperature units can be utilized, such as Celsius and Kelvin.

Dial face 54 further includes a legend 58 of recommended temperatures for meats and degree of doneness. As depicted in FIG. 3, the legend includes 145 degrees Fahrenheit for rare beef, 160 degrees Fahrenheit for medium beef, 170 degrees for well done beef and pork, and 180 degrees Fahrenheit for chicken. It should be appreciated that variations in recommended temperatures for meats and degree of doneness can exist as known to one of ordinary skill in the art. It should be appreciated that the legend of recommended temperatures for a deep fry thermometer can be different. For example, the legend can include recommended oil temperatures for deep frying various meats and other food products or recommended temperatures for syrups and candies. The legend 58 is printed on the dial face 54 with an ink or other suitable marking material. In at least one embodiment, a black ink is utilized.

Dail face 54 is partially coated or printed with a dial face coating 78. In certain embodiments, the dial face coating 78 is a luminescent composition. It should be appreciated that a luminescent composition can be any composition that is capable of a relatively low temperature emission of light. In at least one embodiment, the relatively low temperature is ambient temperature. According to one category of luminescent compositions, the compositions are capable of absorbing energy in the form of light and/or heat and emitting at least a portion of this stored energy in the absence of light, thereby generating “glowing light”. The luminescent composition can be a photoluminescent composition, e.g. phosphorescent or fluorescent composition. It should be appreciated that luminescent compositions are available in a variety of colors. Luminescent compositions are also available in a range of intensities.

According to FIG. 3, the dial face coating 78 is a product of printing a luminescent ink onto the dial face 54. According to one embodiment, the luminescent ink can be obtained from Wing Shing Chemical Company Ltd. of Hong Kong. It should be appreciated that the luminescent ink can also be applied through a coating process known to one of ordinary skill in the art, e.g. dip coating or roller coating.

The upper surface of pointer indicator 50 is at least partially coated or printed with a pointer indicator coating 80. In certain embodiments, the pointer indicator coating 80 is a luminescent composition, for example, a luminescent ink. The luminescent ink can be coated onto the upper surface through a coating process, e.g. dip coating or roller coating. According to one embodiment, the luminescent ink can be obtained from Wing Shing Chemical Company Ltd. of Hong Kong. It should be appreciated that the luminescent ink can also be applied through a printing process known to one of ordinary skill in the art. While utilizing the thermometer 10 in low light or dark conditions, the pointer indicator coating 80 provides a glowing light that enhances the visibility of the pointer indicator 50 for the user. In the embodiment shown in FIG. 3, the combination of dial face coating 78 and indicator coating 80 enhances the visibility of the temperature reading in low light or dark conditions. It should be appreciated that other embodiments contemplate the use of only a pointer indicator coating, which also brings about a beneficial result. Moreover, in at least one embodiment, the entire upper surface of the pointer indicator is coated with a luminescent composition.

In at least one embodiment, the outer surface of the desired temperature pointer indicator 60 is at least partially coated with a luminescent composition. In one embodiment, at least the pointed end 62 is coated with the luminescent composition.

Dail face 54 also includes circular indicia 82 which serve to signify recommended cooking temperatures for beef rare, beef medium, beef well done, pork and chicken. The circular indicia 82 are printed on the dial face 54 with an ink or other suitable marking material. In at least one embodiment, a black ink is utilized. In at least one embodiment, the areas within circular indicia 82 are at least partially coated with a luminescent composition. It should be understood that other shapes can be used as recommended cooking temperature indicia, such as triangle, rectangle, etc.

According to one embodiment of the present invention, a combination of a dial face luminescent coating and pointer indicator luminescent coating is provided. The luminescent coatings can be comprised of the same luminescent composition. Alternatively, the dial face luminescent coating is comprised of a first luminescent composition and the pointer indicator luminescent coating is comprised of a second luminescent composition. The first luminescent composition can differ from the first luminescent composition based on color. For example, the glowing light produced by the first luminescent composition can be a shade of green and the second luminescent composition can be a shade of orange to provide an advantageous contrast between the dial and pointer to further enhance visibility under low light or dark conditions. As another non-limiting example, the glowing light produced by the first luminescent composition can have a first intensity and the second luminescent composition can have a second intensity to provide an advantageous contrast between the dial and pointer to further enhance visibility under low light or dark conditions. In one embodiment, the first intensity is greater than the second intensity. In another embodiment, the second intensity is greater than the first intensity.

In another embodiment, a combination of a dial face luminescent coating, a pointer indicator luminescent coating, and recommended cooking temperature indicia luminescent coating is provided. The luminescent coatings can be comprised of the same luminescent composition or at least two of the three coatings can be comprised of the same luminescent composition. Alternatively, the dial face luminescent coating is comprised of a first luminescent composition, the pointer indicator luminescent coating is comprised of a second luminescent composition, and the cooking temperature indicia luminescent coating is comprised of a third luminescent composition. The first, second and third luminescent compositions can differ from one another based on color. For example, the glowing light produced by the first luminescent composition can be a shade of green, the second luminescent composition can be a shade of orange, and the third luminescent composition can be a shade of yellow to provide an advantageous contrast between the dial, pointer, and recommended cooking temperature to further enhance visibility under low light or dark conditions. As another non-limiting example, the glowing light produced by the first luminescent composition can have a first intensity, the second luminescent composition can have a second intensity, and the third luminescent composition can have a third intensity to provide an advantageous contrast between the dial, pointer, and recommended cooking temperature indicia to further enhance visibility under low light or dark conditions. In one embodiment, the first intensity is greater than the second and third intensities. In another embodiment, the second intensity is greater than the first and third intensities. In yet another embodiment, the third intensity is grater than the first and second intensities.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A thermometer comprising:
a dial plate having a dial surface including indicia;
a temperature probe; and
an indicator overlying and moveable relative to the dial plate and the indicia thereon to indicate a temperature reading corresponding to the temperature of the probe,
at least a portion of the indicator having a luminescent composition to provide a glowing light to enhance visibility of the temperature reading under low light conditions.

2. The thermometer of claim 1, wherein the dial plate is at least partially coated with a luminescent composition to provide a glowing light to enhance visibility of the temperature reading under low light conditions.

3. The thermometer of claim 1, wherein the entire indicator is coated with a luminescent composition.

4. The thermometer of claim 1, wherein the dial surface includes recommended cooking temperature indicia.

5. The thermometer of claim 4, wherein the recommended cooking temperature indicia are coated with a luminescent composition to provide a glowing light to enhance visibility of the temperature reading under low light conditions.

6. The thermometer of claim 2, wherein the dial plate coating is a first luminescent composition, and the indicator coating is a second luminescent composition.

7. The thermometer of claim 6, wherein the first and second luminescent compositions differ from one another.

8. The thermometer of claim 6, wherein the first and second luminescent compositions are luminescent inks.

9. The thermometer of claim 7, wherein the first luminescent composition emits glowing light of a first color and the second luminescent composition emits light of a second color, the first and second colors differ from one another.

10. The thermometer of claim 7, wherein the first luminescent composition emits glowing light of a first intensity and the second luminescent composition emits light of a second intensity, the first and second intensities differ from one another.

11. A thermometer comprising:
a dial plate having a dial surface including indicia;
a temperature probe; and
an indicator overlying and moveable relative to the dial plate and the indicia thereon to indicate a temperature reading corresponding to the temperature of the probe,
at least a portion of the indicator having a first luminescent composition and at least a portion of the dial plate having a second luminescent composition to provide a glowing light to enhance visibility of the temperature reading under low light conditions.

12. The thermometer of claim 11, wherein the first and second luminescent compositions differ from one another.

13. The thermometer of claim 11, wherein the first and second luminescent compositions are luminescent inks.

14. The thermometer of claim 11, wherein the first luminescent composition emits glowing light of a first color and the second luminescent composition emits light of a second color, the first and second colors differ from one another.

15. The thermometer of claim 11, wherein the first luminescent composition emits glowing light of a first intensity and the second luminescent composition emits light of a second intensity, the first and second intensities differ from one another.

16. A thermometer comprising:
an elongated probe assembly comprised of:
an elongated temperature probe; and
a shaft situated within the elongated temperature probe and capable of rotational movement in response to a change in temperature of the probe; and
a dial case assembly comprised of:
a dial plate having a dial surface including indicia arranged in a circular configuration; and
an indicator overlying and rotatably moveable relative to the dial plate and the indicia thereon to indicate a temperature reading corresponding to the temperature of the probe, the indicator rotatably moveable in response the rotational movement of the shaft,
the elongated probe assembly and dial case assembly being rigidly connected, and
at least a portion of the indicator having a luminescent composition to provide a glowing light to enhance visibility of the temperature reading under low light conditions.

17. The thermometer of claim 16, wherein the dial plate is at least partially coated with a luminescent composition to provide a glowing light to enhance visibility of the temperature reading under low light conditions, the dial plate coating is a first luminescent composition, the indicator coating is a second luminescent composition, the first and second luminescent compositions differ from one another.

18. The thermometer of claim 17, wherein the first and second luminescent compositions are luminescent inks.

19. The thermometer of claim 17, wherein the first luminescent composition emits glowing light of a first color and the second luminescent composition emits light of a second color, the first and second colors differ from one another.

20. The thermometer of claim 17, wherein the first luminescent composition emits glowing light of a first intensity and the second luminescent composition emits light of a second intensity, the first and second intensities differ from one another.
